(19) United States
(12) Patent Application Publication
(10) Pub. No.: US 2013/0085898 A1
(43) Pub. Date: Apr. 4, 2013

(54) 3D version of self-choosing a rental car or truck online and business solution for the car and truck rental business

(71) Applicant: Qiuhang Qian, Marble Falls, TX (US)

(72) Inventor: Qiuhang Qian, Marble Falls, TX (US)

(73) Assignee: Qiuhang Richard Qian, Marble Falls, TX (US)

(21) Appl. No.: 13/136,319

(22) Filed: Jul. 29, 2011

Related U.S. Application Data
(60) Provisional application No. 61/508,022, filed on Jul. 14, 2011.

(51) Int. Cl. G06Q 30/00

(52) U.S. Cl. 705/27.2

(57) ABSTRACT

The present invention provides the solution for self-picking a rental vehicle online and the vehicle management method for the vehicle rental business. The customers can check any available rental vehicles online in a particular rental location. A rental vehicle location can be in a city or at an airport. The e-commerce web application contains two modules. The first module is for the customers to use. The second one is for the vehicle rental companies' internal use. Both of them are developed by .net and java. The e-commerce web application will be carefully integrated with the current car rental companies' system or replace their current model. .Net and java are development languages. The web application contains logic rules, packages, procedures, and triggers along with creation tools. The consumers log onto the internet, find a vehicle rental location, check the available vehicles, pick one that they like to drive, and make reservation online. The vehicle rental business and the trained staff will create all the online services for the customers to use by following the developed steps and manage the online web application.

### CROSS REFERENCE TO RELATED APPLICATIONS

Not Applicable

### STATEMENT OF FEDERALLY SPONSORED RESEARCH OR DEVELOPMENT

Not Applicable

### THE NAMES OF THE PARTIES TO A JOINT RESEARCH AGREEMENT

Not Applicable

### REFERENCE TO A “SEQUENCE LISTING,” A TABLE, OR A COMPUTER PROGRAM

In the Development

Choosing a rental car or truck by oneself online and the business solution for the rental vehicle companies have been invented. By choosing a rental vehicle online, the customers can select any available vehicle they want to drive. The present invention also provides the vehicle management solution for the vehicle rental business internal use.

The web application will help the customers check all the rental vehicles, the status of each vehicle such as the mileage, year, and model etc. It will also show where the vehicle parks. The customers can choose the vehicle they like to drive and make reservation online. It will reduce waiting time on the line when it is busy and balance the workload for the vehicle rental business staff.

The customers log onto the internet and access to the website where on the first page there is a 3D virtual simulation of a vehicle rental facility rotating and displaying for 5 seconds before it stops. There is a search block on the upper right corner for the customers to search. The search function is for searching a vehicle rental location(s) in a city or at an airport. The customers can search promotions as well. After the search is done, the results will appear. The results will be either 3D image simulations of all the vehicle rental companies in the search area or the promotions and special offers.

Pointing the cursor to the image of a vehicle rental location, it will show the rental location's contact information including the telephone number, address, map and website etc. Clicking it, the picture will enlarge to the full screen and the next page will show all the available rental vehicles in the parking lot. Pointing to the vehicle, the image will enlarge with the detail description of the rental vehicle. It includes maker, model, year, mileage, color, door type, license plate number, rate and specials if there are any. If the vehicle is clicked, a reservation form will appear for making reservation online. The reservation won't be able to be made beyond three days. A reminder will appear on the screen. Under the image of each vehicle, there are small tabs that will be image and video linked to show the interior of the vehicle. The customers fill out the reservation sheet and make reservation. The reservation information will be sent and saved in the LogC under the Reservation and Return Lot (C stands for choosing vehicle online). The customers can also reserve a vehicle beyond three days or any day by clicking the Customer Service Center tab. The reservation information will be saved and sent to the LogP under the Reservation and Return Lot (P stands for picking vehicle at the rental site).

The customers who pick a vehicle and make reservation online go to the vehicle rental business. The paperwork and the key are ready at the counter. The customers show their driver's licenses, picks up the paperwork, key and find the vehicle according to the parking lot printed on the reservation sheet. The vehicle is ready for driving.

### BACKGROUND OF THE INVENTION

The US car and truck rental and leasing industry includes about 5,000 company locations. Major companies include Avis Budget Group, Enterprise Holdings, Hertz Global Holdings, Ryder, and U-Haul International etc. The current business practice is that the customers go to the vehicle rental site to rent a vehicle or make reservation online. Their choice is limited to the size of the rental vehicle. There are some problems of this practice. According to a survey among 1,300 business travelers who volunteer information for USA TODAY's Road Warrior Panel finds complaints of fewer choices of models, longer lines, long waiting time at the counter and less service. Other complains include that some customers could not get their desired car class; no cars were available; downgraded the car class at the site; or no service was offered in the early morning etc.

With the current invention, the customers can pick a vehicle that they like to drive online and at the site. The staff of the vehicle rental companies can balance the workload, provide quick service, and increase efficiency while the customers will have the option to rent the traditional way or use the invented method. The customers will enjoy the convenience, reduce time on the waiting line, choose the vehicle they want to drive and have different driving experience.

### SUMMARY OF THE INVENTION

The present invention provides the method and solution for both the vehicle rental business and the customers. The vehicle rental business will use the online developed web application to create the services for the customers to use and manage the rental vehicles. The customers can check any available vehicle online. The e-commerce web application contains two modules. The first module is for the customers to use. The second one is for the vehicle rental companies' internal use. Both of them are developed by .net and java. .Net and java are development languages. The web application is compiled with logic rules, packages, procedures, and triggers along with other development tools. The consumers log onto the internet, find a vehicle rental location, check the available rental vehicles, pick one that they like to drive, and make reservation online. The present invention will be easy to use for both the vehicle rental business and the customers. The new method and solution will provide quick service, increase the efficiency and balance the workload for the staff. The customers will have the option to rent the traditional way or use the invented method.

### TECHNICAL FIELD

The present invention is related to the website, computer and server systems that are capable of running and support e-commerce application and programs. More particularly, the present invention is related to the systems that are capable of running the web application and provide the services for online self-choosing rental vehicle and managing the rental vehicles.

### DESCRIPTION OF THE DRAWINGS

FIG. 1 is an example design layout showing how a vehicle rental company's parking lot looks like on the web page.

FIG. 2 is an example page design layout showing how the internal management console looks like on the vehicle rental companies' local computers.

FIG. 3 is a logic process flow diagram illustrating how technically the platform is created for the customer to choose and reserve a rental vehicle and use other services online.

FIG. 4 is a logic process flow diagram illustrating how technically the platform is created for the vehicle rental business to build the service items for the customers to use and manage the vehicles.

### DETAILED DESCRIPTION OF THE INVENTION

The present invention provides the solution of self-choosing a rental vehicle for the customers online, at the site and the business solution for the vehicle rental business. The local vehicle rental business needs to be authorized to access to the Management Console. The customer service associates will be granted to have the privilege by the corporate office if the local rental business is part of the rental chain business. The customer service associates need to have account to access to the Management Console if the local rental business is an independent one.

The local and corporate office can create, modify, delete, move, upload, update and check the status of the rental vehicles. The vehicle rental business can follow the procedures developed and perform different tasks in the Management Console. The related service contents that are created or updated will be saved on the server. There are programs that will automatically be initiated to help the web application run smoothly. The customers have the option to create an account, but they are not required to. The rental information and records will be automatically saved. They can be retrieved from the server.

Although the preferred embodiment will be generally described in the context of website, programs and the operating systems running on the computers and servers, those skilled in the art will recognize that the present invention also can be implemented in conjunction with other program modules for different types of computers and servers. Furthermore, those skilled in the art will recognize that the present invention may be implemented in different network environments.

For example, in a two-tier network, a user communicates directly with a server. This is also known as the client-server architecture. The client-server network is an architecture that involves user processes that request the service from server processes. The user and server communicate over a network using a given protocol, which must be installed on both the user and the server. This method can be applied to any independent local vehicle rental business.

In an N-tier architecture, the role of the middle-tier agent is manifold. It will provide: translation services (as in adapting a legacy application on a mainframe to a user-server environment or acting as a bridge between protocols); scalability services (as in acting as a transaction-processing monitor to balance the load of requests between servers); intelligent agent services (as in mapping a request to a number of different servers, collating the results, and returning a single response to a user). The N-tier architecture can be built for multi vehicle rental locations.

In a complex network environment, different hardware platforms run different operating systems; multiple protocols are used on these platforms; variable syntax exist between the different but connected applications; run on different geographical locations in which the connected applications reside. It supports a large-scale distributed system. In a distributed computing and server environment, the program modules may be physically located in different local and remote memory storage devices. The execution of the program modules many occur locally in a stand-alone manner or remotely in a user server manner. Examples of such distributed computing and server environments include local area networks of an office, enterprise-wide computer networks and the global internet.

The detailed description which follows is represented largely in terms of processes and symbolic representations of operations by conventional computer and server components, including central processing units (CPU), memory storage devices for the CPU(s), display devices, and input devices. Furthermore, these processes and operations may utilize conventional computer and server components in a heterogeneous distributed computing and server environment, including remote file servers, remote computer servers, and remote memory storage devices. Each of these conventional distributed components is accessible by the CPU via communication network. The processes and operations performed by the computer include the manipulation of signals by a CPU or remote server and the maintenance of these signals within data structures resident in one or more of the remote memory storage devices.

For the purpose of the discussion, a process is generally conceived to be a sequence of computer-executed steps leading to a desired result. These steps usually require physical manipulation of physical quantities. Usually, though not necessarily, these quantities take the form of electrical, magnetic, or optical signals capable of being stored, transferred, combined, compared, or otherwise manipulated. It is convention for those skilled in the art to refer to representation of these signals as bits, bytes, words, information, elements, symbols, characters, numbers, points, data, entries, objects, images, files, or the like. It should be kept in mind that these and similar terms are associated with appropriate physical quantities for the computer operations, and that these terms are merely conventional labels applied to physical quantities that exist within and during operation of the computer.

It should also be understood that manipulations within the computer are often referred to in terms such as creating, adding, changing, modifying, saving, calculating, updating, moving, receiving, determining, identifying, populating, loading, executing, etc. that are often associated with manual operations performed by a human operator. The operations described herein can be machine operations performed in conjunction with various input provided by a human operator or a user that interacts with the computer.

In addition, it should be understood that the programs, processes, methods, etc. described herein are not related or limited to any particular computer or apparatus. Rather various types of general purpose machines may be used with the program modules constructed in accordance with the teachings described herein. Similarly, it may prove advantageous to create specialized programs to perform the method steps described herein by the way of dedicated computer and server systems in specific network architecture with hardwired logic stored in nonvolatile memory devices.

Such architect structures impose a physical organization upon the collection of data stored within the memory storage device and represent specific electrical or magnetic elements. These symbolic representations are the means used by those skilled in the art of computer programming to most effectively convey teachings and discoveries to other skilled in the art. Now referring to the figures:

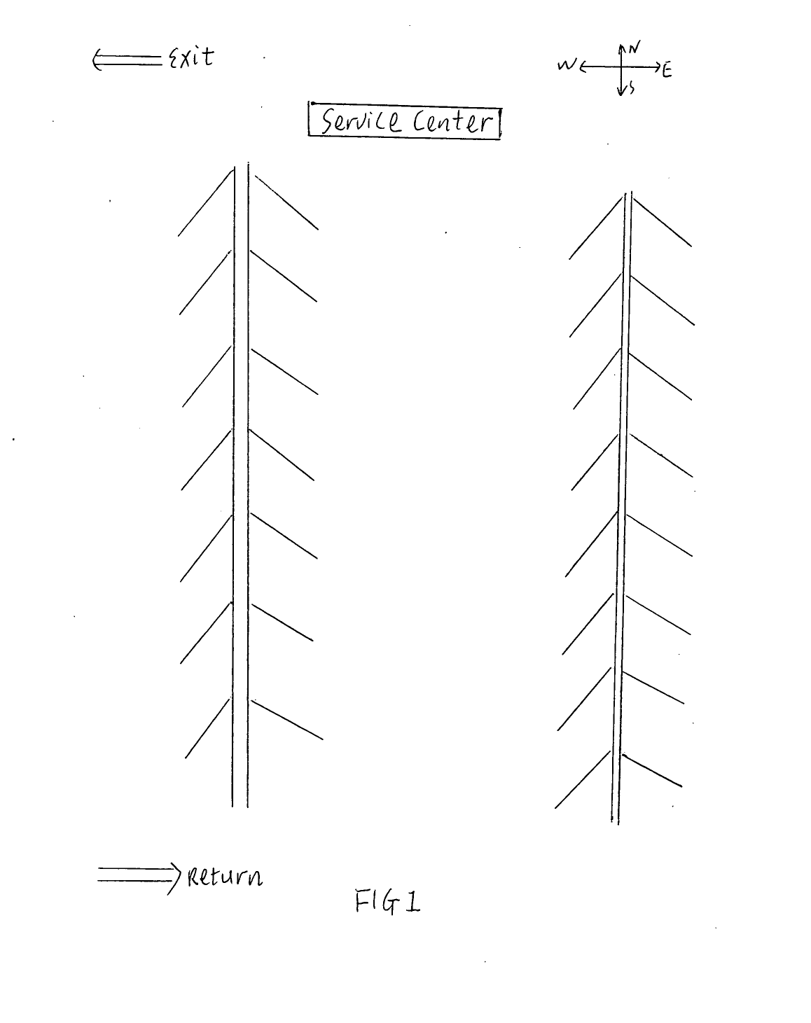

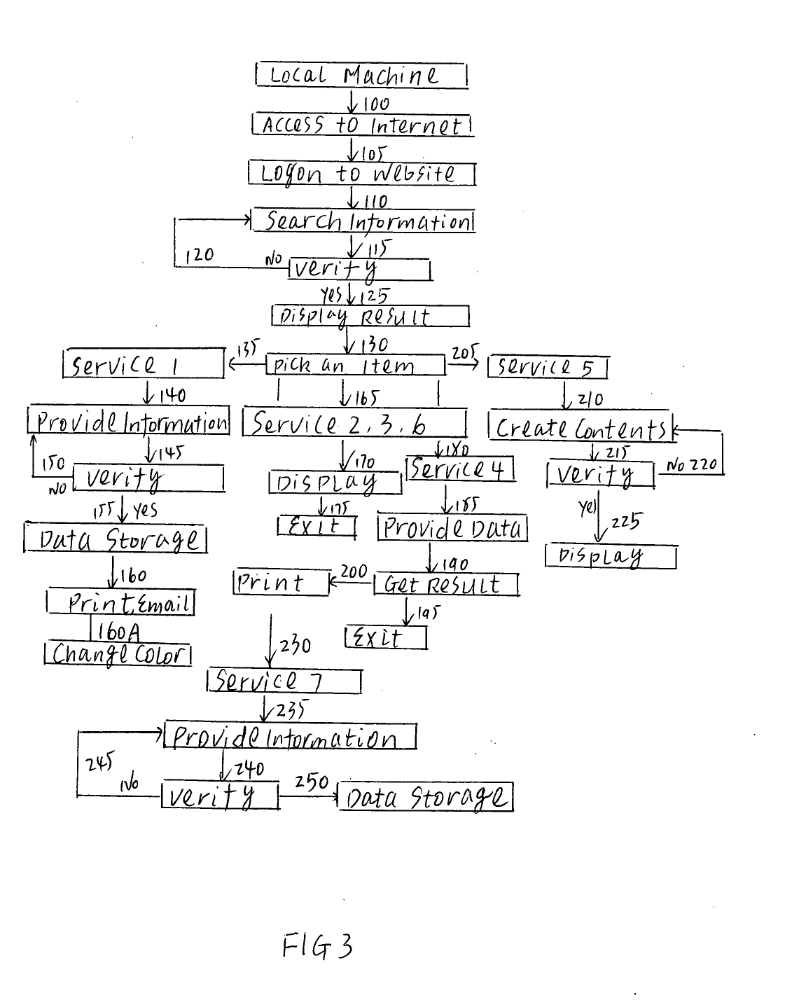

FIG. 1 looks similar to the web page showing a car rental's parking lot after the search. It is an example of the vehicle parking lot layout. Different vehicle rental businesses have different parking lots. The parking lots have different sizes, shapes and directions. The information of the local rental location(s) will be gathered. The information will include the rental company's address, number of cars, directions, pictures and detailed description. A compass is put on the parking lot page for direction. There will be pictures exactly the same as the real rental facility and parking lot with vehicles. The customers can click and check. The Customer Service Center tab is provided on the top middle. It provides the link for several services including make reservation online in the traditional way. See FIG. 3 for the detailed description.

The customer user interfaces are developed by .Net and Java. The compiled programs are stored units. They will enable the customers to access to the web application and create contents using procedural schema objects. Stored program units are a logically related set of language statements that perform a specific task. They are called by triggering. They can be procedures, functions, triggers, or packages and are developed and stored in the data dictionary as a schema object.

The stored procedure is a procedure or function. It consists of a set of .Net and java constructs. Procedures and functions are identical except that functions always return a single value to the caller, while the procedures do not. The trigger is a program unit that is executed implicitly by the server when a specific type of event occurs. The trigger is never called only when it will execute when an event occurs. A package is a group of functionally related variables, constrains, cursors, exceptions, procedures, and functions stored together in the database as a unit. Packaged procedures and functions can be called explicitly by the applications or users. The package usually has two parts stored separately in the database: A). The specification is the interface to the application and declares the types, variables, constraints, exceptions, cursors, and sub programs available for use outside of the package; B). The body implements the specification. It includes the codes to implement the procedure and function specification included in the package specification. It may also include procedures and functions that are callable only from inside of the package. The functionality of a package is similar to that of stored procedures. The other development tools include the design studio and word processing editor etc.

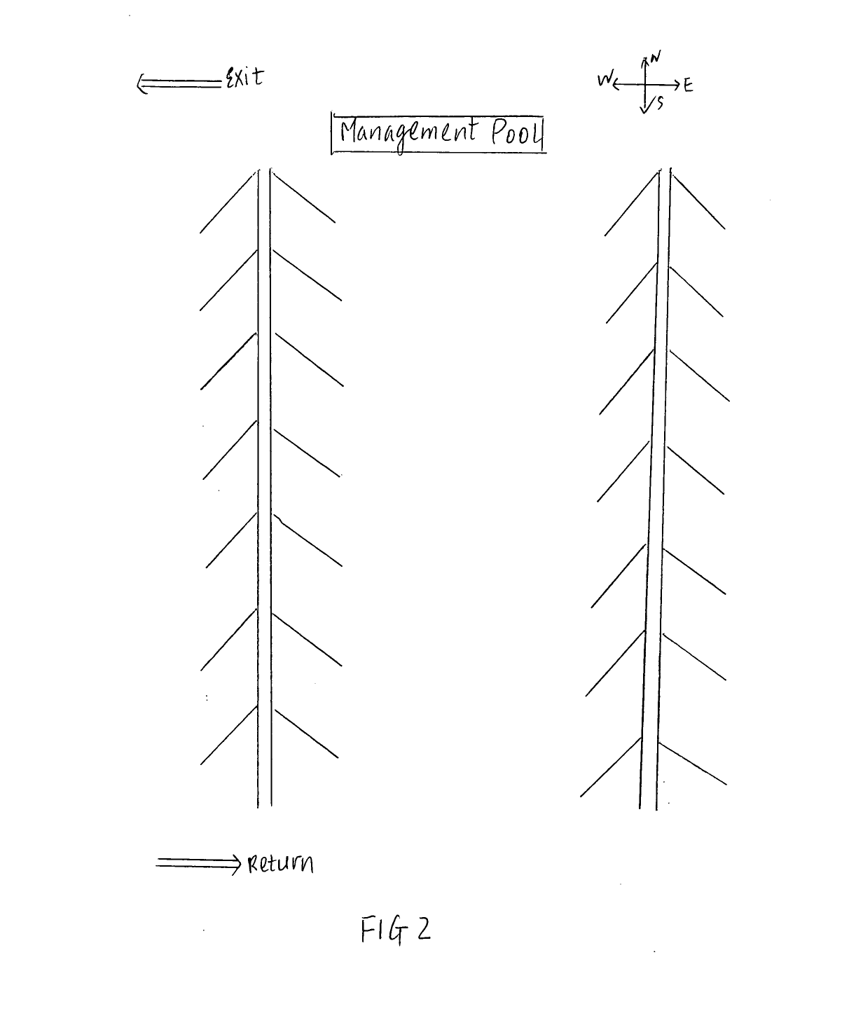

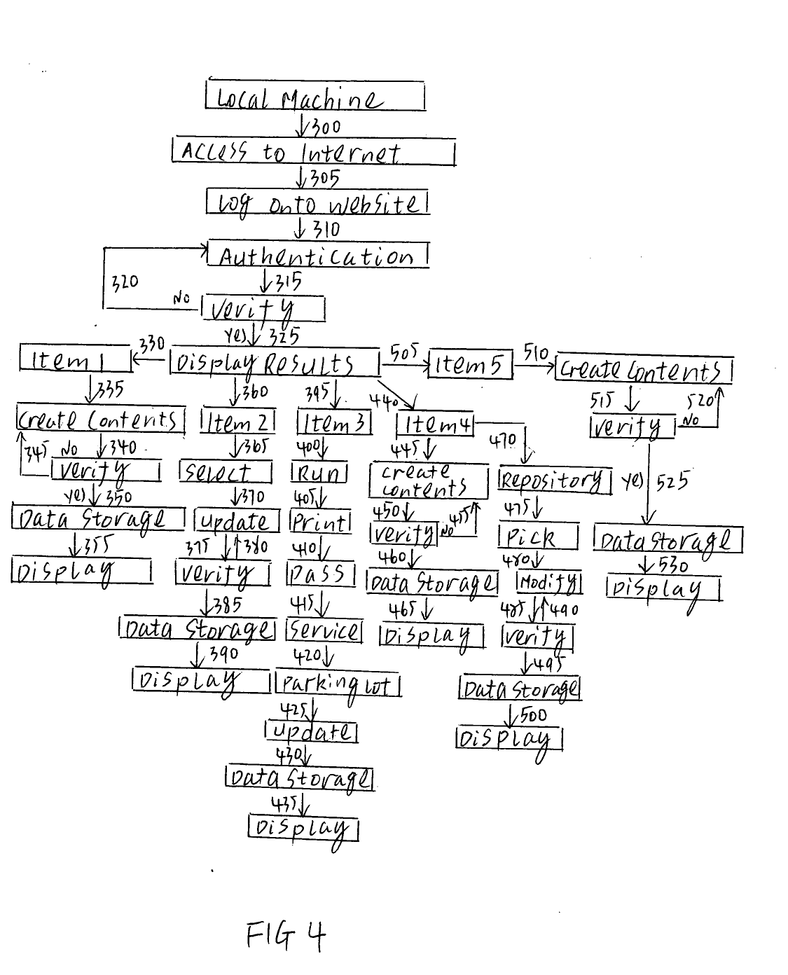

FIG. 2 looks similar to the web page showing the internal Management Console. It has the exact page layout as the FIG. 1 except that the color of the page is different and the tab on the top middle will be the Management Console instead of the tab of Customer Service Center on the user interface for the customers. The local vehicle rental business associates can perform different tasks from here including creating content materials for the rental vehicles. There are other task modules under the Management Console. For the detailed management tasks, see FIG. 4 for the detail description.

The Management Console interfaces are developed by .Net and Java. They are compiled program stored units. They will enable the local businesses to access to the Management Console and manipulate information contents using procedural schema objects. The stored program units are a logically related set of language statements that perform a specific task. They are called by triggering. They can be procedures, functions, triggers, or packages and are created and stored in the data dictionary as a schema object.

The stored procedure is a procedure or function. It consists of a set of .Net and java constructs. Procedures and functions are identical except that functions always return a single value to the caller, while the procedures do not. The trigger is a program unit that is executed implicitly by the server when a specific type of event occurs. The trigger is never called only when it will execute when the event occurs. A package is a group of functionally related variables, constrains, cursors, exceptions, procedures, and functions stored together in the database as a unit. Packaged procedures and functions can be called explicitly by the applications or users. The package usually has two parts stored separately in the database: A). The specification is the interface to the application and declares the types, variables, constraints, exceptions, cursors, and sub programs available for use outside of the package; B). The body implements the specification. It includes the codes to implement the procedure and function specification included in the package specification. It may also include procedures and functions that are callable only from inside of the package. The functionality of a package is similar to that of stored procedures. Other development tools include the design studio and word processing editor etc.

FIG. 3 is the diagram showing the user's interface process flow. The customers log into a local computer, connect to the internet and access to the web server (Step 100, 105). The connection is a communication pathway between the user process and the server process. A process created on the client is called the user process. It generates the request from the client on the local machine. A server process is a process passed from the user process and executes on the server. During the server process, it listens, receives, parses and executes the request sent from the user process. The process communicates with the server on behalf of the user process. The server process executes the request. After the process finishes, the returned result is sent back to the customers.

The web application displays the graphic interface which is the first page of the website after the service request returns. The first page is made up of two different items. Items are used to present information from the database or to act as control. The web application is event-driven. When an event occurs, the application responds to it. An event is either an interface event, which corresponds to a customer action, or an internal processing event, which corresponds to a system action.

The first item is the 3D artificial vehicle rental facility. It is shown in the middle of the screen. The second item is the search block. The 3D vehicle rental facility will be rotated and displayed for 5 seconds before it stops. The search block is put at upper right corner. Step 110 is the step for the customers to search vehicle rental location. The search information will be parsed (Step 115). If it cannot be found in the database, the process goes back to the step 110 through the step 120. During the parsed stage, the development functional program is invoked. It provides a default verification routine to verify the validity of the data in the database. The procedure returns the value TRUE for success and FALSE for failure. If the parse raises an exception, the data becomes invalid, an error returns.

If the data are valid, the web page will show all the picture images of the found vehicle rental businesses (Step 125). The next step 130 is the step that the customers choose a vehicle rental business by pointing and clicking the image. If the image is pointed, the business contact information shows on the screen. It includes the address, telephone and map etc. If it is clicked, the image will enlarge to the full screen. A navigation arrow will led to the car customer Service Center page where the parking lot shows all the rental vehicles. The vehicles are for the customers to be checked and picked for reservation online.

Step 135 is the step that the customers pick Service 1. Service 1 is for the customers to self-picking a rental vehicle that they like to drive and make reservation online. If the vehicle is pointed, it becomes full screen and the detailed information of the vehicle shows on the screen which includes maker, model, year, mileage, color, license plate, door type, transmission type, and rental rate etc. Under each vehicle there are small tabs linked to the interior image of the vehicle and the video. The customers can keep checking all the available vehicles until they pick the one that they like to drive. If the image of the vehicle is clicked, a reservation form shows on the screen. The next step is the step that the customers fill out the reservation form (Step 140). The reservation information needs to be verified (Step 145). If the data are not valid, the process goes back to the step 140 until the valid data are provided through the step 150. If the data are valid, they will be saved on the server (Step 155). The customers can print out the reservation form with the parking lot information or choose to send the reservation information to their email account (Step 160). The reserved vehicle on the parking lot space changes the color from green to red after the reservation meaning it has been rented (Step 160A). The reservation information will be saved in the database on the server for the local rental vehicle businesses under LogC in the Management Console's Reservation and Return Lot.

The customer reservation and vehicle information are collected in the database files. During the reservation save stage, the server records the data and writes them to the data blocks in the database from database buffer cache. The purpose of the database is to store and retrieve related information. The database has a logical and physical structure. The physical structure of the database is the set of operating system files in the database. The database consists of A). Data files. Data files contain the actual data in the database. The data is stored in user-defined tables, but data files also contain the data dictionary, before-images of modified data, index, and other types of structures. They form a logical unit of database storage called tablespace. The data files have certain characteristics set to allow them automatically extend when the database runs out of space. B). Redo log files. Redo logs contain a record of changes made to the database to enable recovery of the data in case of failures. C). Control files. Control files contain information necessary to maintain and verify database integrity. The reservation for online self-picking a rental vehicle cannot be made beyond three days. A reminder will show on the screen.

The customers can also make online reservation beyond three days and pick other services by clicking the Customer Service Center tab (Step 130). Step 165 is the step for the customers to choose either Service 2, 3 or 6. Service 2 is about promotion. It will show the special offers and promotions if there are any when the service is clicked; Service 3 is about vehicles for sale; Service 6 is the map of the rental vehicle business. The contents for Service 2, 3 and 6 will be shown if they are clicked (Step 170). The process ends when the customers leave each service (Step 175). Service 4 is about rental history records with rewarding system. If the customers choose this service (step 180), they need to provide personal information. After the customers provide the information, the results will show on the screen (Step 185, 190). If the result is good, the customers can print it or save it (Step 200) or the customers can exit if there is no result (Step 195).

Service 5 is comments and suggestion. If the customers select Service 5 (Step 205), they need to create contents (Step 210). The created contents need to be verified (Step 215). If they are not good, the process goes back to the step 210 through the step 220. If the contents are good, they will be displayed (Step 225). Service 7 is for the customers to make reservation beyond three days (Step 230). Service 7 is the traditional vehicle rental reservation way. If the customers choose this option, they need to request and fill out the reservation sheet (Step 235). The reservation information provided by the customers need to be verified (Step 240). If the data are not valid, the process goes back to the step 235 until the valid data are provided through the step 245. If the data are valid, they will be saved in the LogP under the Reservation and Return Lot of the Management Console (Step 250).

The online vehicle rental reservation module for the customers is developed by .Net and Java. They are compiled program stored units. They will enable the local businesses to access to the Management Console and manipulate information contents using procedural schema objects. The stored program units are a logically related set of language statements that perform a specific task. They are called by triggering. They can be procedures, functions, triggers, or packages and are created and stored in the data dictionary as a schema object.

The stored procedure is a procedure or function. It consists of a set of .Net and java constructs. Procedures and functions are identical except that functions always return a single value to the caller, while the procedures do not. The trigger is a program unit that is executed implicitly by the server when a specific type of event occurs. The trigger is never called only when it will execute when the event occurs. A package is a group of functionally related variables, constrains, cursors, exceptions, procedures, and functions stored together in the database as a unit. Packaged procedures and functions can be called explicitly by the applications or users. The package usually has two parts stored separately in the database: A). The specification is the interface to the application and declares the types, variables, constraints, exceptions, cursors, and sub programs available for use outside of the package; B). The body implements the specification. It includes the codes to implement the procedure and function specification included in the package specification. It may also include procedures and functions that are callable only from inside of the package. The functionality of a package is similar to that of stored procedures. Other development tools include the design studio and word processing editor etc.

FIG. 4 is the diagram showing the process flow of the Management Console for the rental vehicle business internal use. The vehicle rental associates log into the computer, connect to the internet and access to the web server (Step 300, 305). The connection is a communication pathway between the local business and the server process. The connection is a communication pathway between the user process and the server process. A process created on the client side is called the user process. It generates the request from the client on the local machine. A server process is a process passed from the user process and executes on the server. During the server process, it listens, receives, parses and executes the request sent from the user process. The process communicates with the server on behalf of the user process. The server process executes the request. After the process finishes, the result returns back to the associates.

Step 310 is authentication. The rental business associates provide the access information to be authenticated (Step 315). If the authentication is not valid, the process needs repeat until the valid access data are provided through the step 320. If the authentication is valid, it will enter the Management Console (Step 325). During the authentication, the functional program is invoked. It provides a default verification routine to verify the validity of the data. The procedure returns the value TRUE for success and FALSE for failure. If the verification raises an exception, the data becomes invalid, an error is returned. The Management Console is made up of different items. Items are used to present information from the database or to act as control. The web application is event-driven. An event occurs and the application responds to it. An event is either an interface event, which corresponds to an action, or an internal processing event, which corresponds to a system action.

Step 330 is the step to select Item 1 from the Management Console. Item 1 is the Creation Lot. It is where content materials will be created (Step 335). The creating process consists of creating a parking lot, uploading the materials of the rental vehicle including the vehicle pictures and videos; entering vehicle information which includes maker, year, model, mileage, color, door type, and license plate number; the rate, and special. After the creation is done, all the content materials need to be verified (Step 340). If the contents are not satisfactory or incorrect, they need to be re-created through the step 345. If the contents are good, they will be saved in the database on the server and shown on the web page (Step 350, 355).

Step 360 is the step to select Item 2. Item 2 is the Reservation and Return Lot. All the reserved and returned vehicle information is stored here in these two separated modules. The next two steps 365 and 370 are the steps to check and update the information. The updated information needs to be verified (Step 375). If the data are not correct, they need to be updated again through the step 380. If the data are correct, they will be saved on the server and shown on the web page with the rental vehicles (Step 385, 390).

Step 395 is the step to pick Item 3. Item 3 is the Maintenance Lot. The vehicles that are in service or need to be serviced will be updated here. It starts with running the report automatically periodically or manually (Step 400). The next two steps are the steps to print the report and pass it to the service department (Step 405, 410). The service department provides the service and put it back to the parking lot (Step 415 and 420). The vehicle maintenance information will be updated, stored and displayed in the system (Step 425, 430 and 435).

Step 440 is selecting Item 4. Item 4 is the Promotion Lot. The Promotion Lot allows the corporate or local business to create promotional contents in the form of banner ads. The lot contains two parts. The default is set with creation area with the design tools. The second part contains the old promotion design work that has been done. Step 445 is the step to create promotion material using the design tools. After the contents are created, they need to be verified (Step 450). If the contents are not satisfactory, they need to be re-created or modified through the step 455. If the contents are satisfactory, they will be saved and displayed in the promotional area on the web page (Step 460 and 465). Step 470 is the step to retrieve the old design work (Step 475). The next two steps are the steps to modify and verify the new created design work (Step 480 and 485). If the modified contents are not satisfactory, they need to be re-modified through the step 490. If the modified design work is satisfactory, it will be saved and displayed in the promotional area (Step 495 and 500).

Step 505 is the step to choose Item 5. Item 5 is created for rental vehicles for sale online. The For Sale Lot is the area where the rental business associates need to create the materials (Step 510).

The step will include entering the vehicle information such as maker, year, model, mileage, color, door type, transmission type, uploading interior and exterior photo images, video clips, and price etc. After the materials are created, they need to be verified (Step 515). If the content materials are not good, they need to be re-created through the step 520. If the content materials are good, they will be saved in the database on the server and shown under the For Sale tab on the customer's user interface (Step 525, 530).

The databases for saving all the created content materials are a collection of data files. During the save stage, the server records the data and writes them to the data blocks in the database from database buffer cache. The purpose of a database is to store and retrieve related information. The database has a logical and physical structure. The physical structure of the database is the set of operating system files in the database. The database consists of A). Data files. Data files contain the actual data in the database. The data is stored in user-defined tables, but data files also contain the data dictionary, before-images of modified data, index, and other types of structures. They form a logical unit of database storage called tablespace. The data files have certain characteristics set to allow them automatically extend when the database runs out of space. B). Redo log files. Redo logs contain a record of changes made to the database to enable recovery of the data in case of failures. C). Control files. Control files contain information necessary to maintain and verify database integrity.

The internal web vehicle management module including all the development processes for each service item is developed by .Net and Java. .Net and Java are developed for compiling programs. The programs are stored units on the server. They will enable the vehicle rental business associates to access to the Management Console and manipulate information contents using procedural schema objects. The stored program units are a logically related set of language statements that perform a specific task. They are called by triggering. They can be procedures, functions, triggers, or packages and are created and stored in the data dictionary as a schema object.

The stored procedure is a procedure or function. It consists of a set of .Net and java constructs. Procedures and functions are identical except that functions always return a single value to the caller, while the procedures do not. The trigger is a program unit that is executed implicitly by the server when a specific type of event occurs. The trigger is never called only when it will execute when the event occurs. A package is a group of functionally related variables, constrains, cursors, exceptions, procedures, and functions stored together in the database as a unit. Packaged procedures and functions can be called explicitly by the applications or users. The package usually has two parts stored separately in the database: A). The specification is the interface to the application and declares the types, variables, constraints, exceptions, cursors, and sub programs available for use outside of the package; B). The body implements the specification. It includes the codes to implement the procedure and function specification included in the package specification. It may also include procedures and functions that are callable only from inside of the package. The functionality of a package is similar to that of stored procedures. Other tools include the design studio and word processing editor etc.

The process for self-picking a rental vehicle at the rental site is the same as it is on the interne except that the customers can print out the reservation sheet immediately from the workstation. The workstation will consist of computer systems built and set in the designated area with hardware and network connected.

1. METHOD AND SOLUTION FOR (3D Version of Self-Choosing) SELF-PICKING A RENTAL VEHICLE (a Rental Car or Truck Online & Business Solution for the Car and Truck Rental Companies) ONLINE AND AT THE SITE
